(19) United States
(12) Patent Application Publication
(10) Pub. No.: US 2006/0132448 A1
(43) Pub. Date: Jun. 22, 2006

(54) Emulator with key press history

(76) Inventor: Darren Scott Irons, Carrollton, TX (US)

Correspondence Address: TEXAS INSTRUMENTS INCORPORATED, P O BOX 655474, M/S 3999, DALLAS, TX, 75265, US

(21) Appl. No.: 11/017,027

(22) Filed: Dec. 20, 2004

(51) Int. Cl. G09G 5/00

(52) U.S. Cl. 345/169

(57) ABSTRACT

An emulation system that displays a key press history is provided. The emulation system emulates a handheld computing device, such as a calculator, on an electronic device such as a personal computer. A sequence of keystrokes is received by the emulation system, wherein the keystrokes represent input to the handheld computing device being emulated. The keystrokes may represent, for example, digits, commands (e.g., store, recall, graph, list, print, etc.), or functions (e.g., x², x³, compute, tan, sin, cos, etc.). The sequence of keystrokes is displayed by the emulation system, thereby allowing a student to see the key press history. The keystrokes may be entered on the emulation system, or the emulation system may receive the keystrokes from a communicatively coupled handheld device. The emulation system may include a projector for projecting the display onto a screen or other surface.

### CROSS-REFERENCE TO RELATED APPLICATIONS

This application relates to the following co-pending and commonly assigned patent application Ser. No. ______ (Attorney Docket No. TI-37613), filed Dec. 20, 2004, entitled Device Controller for an Emulator; and Ser. No. ______ (Attorney Docket No. TI-39036), filed Dec. 20, 2004, entitled Scripting Support for an Emulator, which applications are hereby incorporated herein by reference.

### TECHNICAL FIELD

The present invention relates generally to emulators and, more particularly to providing key press history for an emulator of a handheld computing device.

### BACKGROUND

Electronic calculators have become a common tool for teaching students various aspects of mathematics. In particular, the features of graphing calculators are particularly advantageous in a classroom setting to teach students mathematical principals and to illustrate practical applications of concepts taught in class. In fact, many schools now recommend or require students in math classes to use graphing calculators to aid students in learning about advanced math topics, such as trigonometry and calculus.

To aid teachers in a classroom setting, emulators have been developed to emulate the functions and display of the calculators on a computer, such as a desktop computer, a laptop computer, or the like, equipped with a display. Emulators typically comprise a graphical user interface (GUI) that illustrates a graphical representation of the physical calculator. Data is entered and functions are controlled by either clicking on specific keys of the graphical representation or using a keyboard to enter the desired data/commands.

During a typical use, a teacher is in front of the computer to control the emulator. The computer running the emulator is coupled to a projector such that the GUI display of the emulator is projected on a screen or other surface, thereby allowing students to watch the teacher illustrate mathematical concepts using the calculator. It is generally preferred that the student follow along on the student's own calculator to practice. Another use of an emulator is in conjunction with an electronic whiteboard. This allows the computer to be projected onto the screen and allows the user to “drive” the emulator which is being projected.

However, if a student misses a keystroke or incorrectly enters a keystroke, the teacher must repeat the lesson. This wastes valuable class time. Hence, there is a need for a way to illustrate the keystrokes entered by a user of the emulator, thereby allowing others to determine the history of keystrokes.

### SUMMARY OF THE INVENTION

These and other problems are generally solved or circumvented, and technical advantages are generally achieved, by preferred embodiments of the present invention which provides a key press history, preferably with a visual representation, for an emulator of a handheld computing device.

In accordance with an embodiment of the present invention, an emulation system is provided. The emulation system comprises a processor configured to perform mathematical operations available on a handheld computing device, a display communicatively coupled to the processor, and memory communicatively coupled to the processor. The memory is further configured to store computer program code to cause the processor to receive a sequence of keystrokes, emulate the handheld computing device in accordance with the sequence of keystrokes, and display a key press history. The sequence of keystrokes may either be entered directly on the emulation system (via a mouse or keyboard, for example) or via an electronic device, such as the handheld computing device being emulated, communicatively coupled to the emulation system. The handheld computing device may be, for example, a calculator or an electronic device configured to emulate a calculator.

In accordance with another embodiment of the present invention, a method of emulating a handheld computing device is provided. The method comprises the steps of receiving a sequence of keystrokes corresponding to a plurality of keys entered on a handheld computing device, emulating behavior of the handheld computing device in accordance with the sequence of keystrokes, and displaying a key press history, wherein the key press history includes an indication of the sequence of keystrokes that had been entered.

In accordance with yet another embodiment of the present invention, a computer program for emulating a handheld device is provided. The computer program includes computer program code for emulating a handheld device, for receiving input indicating a plurality of keys that have been depressed, and for displaying a key press history.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an emulation system in accordance with an embodiment of the present invention;

FIG. 2 illustrates an example of a handheld computing device in accordance with an embodiment of the present invention;

FIG. 3 is a block diagram of an emulation system in accordance with an embodiment of the present invention;

FIG. 4 is an example of a user-interface that may be used in conjunction with the emulation system in accordance with an embodiment of the present invention; and

FIGS. 5-10 are a series of screen shots that an emulation system may utilize to display a key press history in accordance with an embodiment of the present invention.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

Embodiments of the present invention are discussed below with respect to an embodiment utilizing a graphing calculator. It should be noted, however, that embodiments of the present invention may be useful for emulations of any electronic device, particularly handheld computing devices. Examples of other types of handheld computing devices in which embodiments of the present invention may be useful include calculators with a multi-line screen, scientific calculators, advance calculators able to upload and run software applications, handheld-sized limited-purpose computer devices, handheld-sized educational computer devices, handheld-sized portable computer devices having a multi-line screen, portable computer devices having a video screen, personal digital assistants (PDA), palmtop computers, handheld computing devices with a touch screen interface, personal communicators, personal intelligent communicators, cellular or mobile telephones having a multi-line screen, global positioning system (GPS) devices, portable inventory logging computer devices having a multi-line screen (as may be used by courier deliverers, for example), handheld monitoring devices having a multi-line screen (as may be used by meter readers, for example), handheld parking ticket administering devices having a multi-line screen, handheld portable email computer devices having a multi-line screen, handheld portable Internet browsing devices, handheld portable gaming devices, and any combination thereof.

Embodiments of the present invention may be particularly useful in a classroom setting wherein a teacher is utilizing an emulation system to demonstrate mathematical concepts on a calculator, such as a graphing calculator, a scientific calculator, a financial calculator, a programmable calculator, other calculators, or the like. In these embodiments, the handheld computing device may include a calculator or an electronic device configured to emulate a calculator.

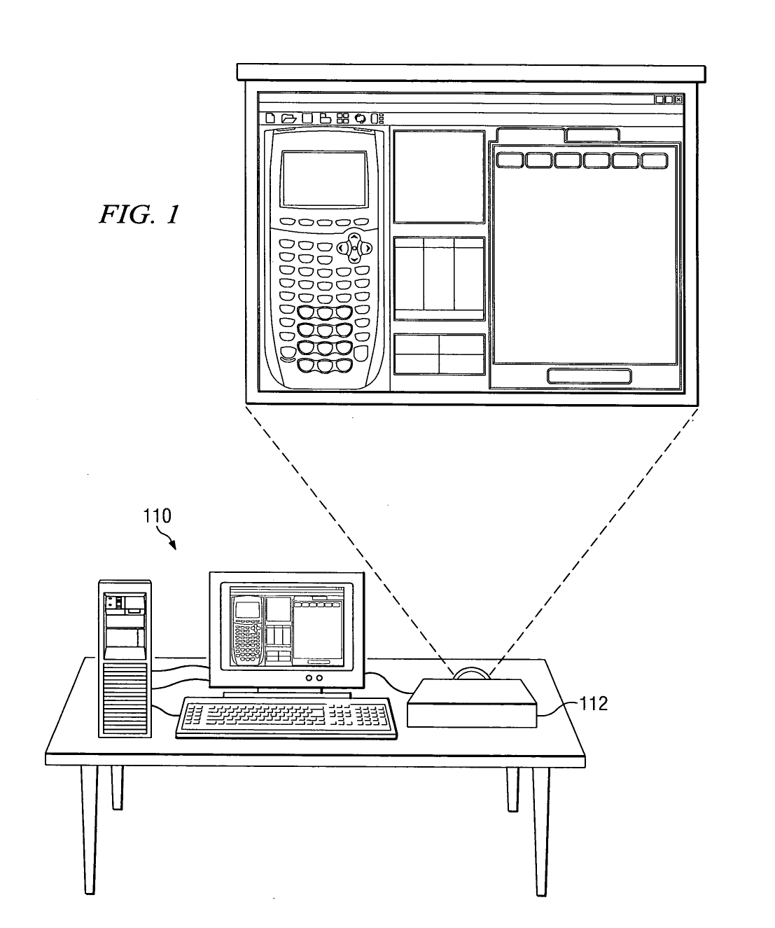

Referring now to FIG. 1, an embodiment of the present invention provides an emulation system 110 communicatively coupled to a projector 112, wherein the emulation system 110 emulates a handheld computing device (not shown). The handheld computing device may be any electronic computing device, such as a calculator. For example, in a preferred embodiment the handheld computing device is a graphing calculator such as the TI-84 Plus graphing calculator manufactured by Texas Instruments, Inc., of Dallas, Tex. The TI-84 Plus is a popular graphing calculator used in 6^{th}-12^{th} grades to illustrate various mathematical concepts. Other types of devices, however, may be used.

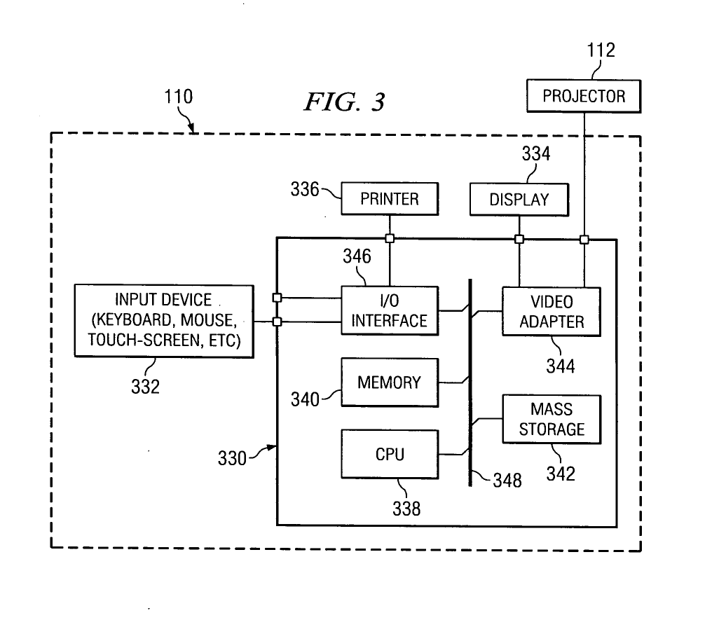

The emulation system 110 may comprise a general purpose computing device, such as a personal computer, a mini-computer, a main frame, a personal data assistant, a laptop computer, or the like, having a display attached thereto. The emulation system is described in greater detail below with reference to FIG. 3.

In operation, as illustrated in FIG. 1, a user (in most cases a teacher) may initiate the emulator on the emulation system 110 during classroom lectures. The emulation system 110 preferably provides a graphical user interface (GUI) comprising a graphical representation of the handheld computing device, e.g., a calculator. The user controls the operation of the emulation in order to illustrate a function of the calculator and/or to illustrate a mathematical concept. As the user controls the emulator on the emulation system 110, the graphical representation of the calculator is enlarged and displayed on a large surface, such as a screen or wall, via the projector 112. In this manner, the user may use the emulation system 110 to demonstrate the use of the handheld computing device and mathematical concepts.

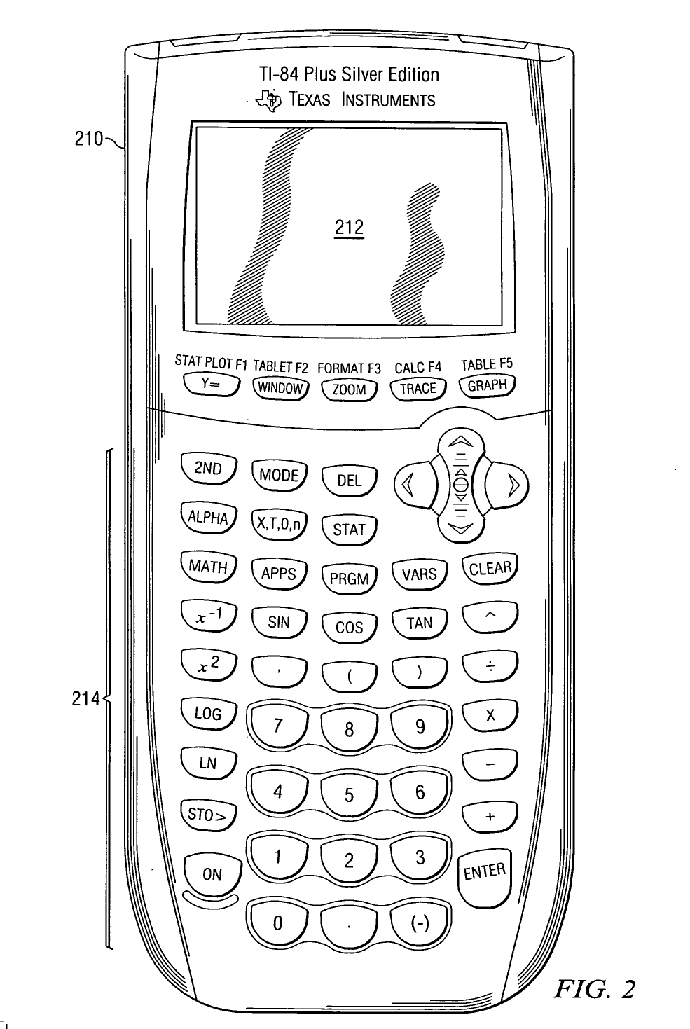

Referring now to FIG. 2, an example of a handheld computing device 210 in accordance with an embodiment of the present invention is shown. For illustrative purposes only, the handheld computing device 210 illustrated in FIG. 2 is similar to a TI-84 Plus graphing calculator.

As shown in FIG. 2, the handheld computing device 210 includes a graphical display 212 and a set of keys 214. The graphical display 212 provides a means upon which graphs of various functions and/or one or more lines of text/symbols may be displayed. The graphical display 212 may be, for example, an LED display. The set of keys 214 is located below the graphical display 212 and provides a method for a user, e.g., a student, to enter data and functions. Other configurations and functions may be used.

FIG. 3 is a block diagram of the emulation system 110 in accordance with an embodiment of the present invention. Generally, the emulation system 110 may comprise a processing unit 330 equipped with one or more input devices 332 (e.g., a mouse, a keyboard, or the like), and one or more output devices, such as a display 334, a printer 336, or the like. The processing unit may be, for example, a desktop computer, a workstation, a laptop computer, a personal digital assistant, a dedicated unit customized for a particular application, or the like.

Preferably, the processing unit 330 includes a central processing unit (CPU) 338, memory 340, a mass storage device 342, a video adapter 344, and an I/O interface 346 connected to a bus 348. The bus 348 may be one or more of any type of several bus architectures including a memory bus or memory controller, a peripheral bus, video bus, or the like. The CPU 338 may comprise any type of electronic data processor. For example, the CPU 338 may comprise a Pentium™ processor from Intel Corp., an Athlon processor from Advanced Micro Devices, Inc., a Reduced Instruction Set Computer (RISC), Application-Specific Integrated Circuit (ASIC), or the like. The memory 340 may comprise any type of system memory such as static random access memory (SRAM), dynamic random access memory (DRAM), synchronous DRAM (SDRAM), read-only memory (ROM), a combination thereof, or the like. In an embodiment, the memory 340 may include ROM for use at boot-up, and DRAM for data storage for use while executing programs.

The mass storage device 342 may comprise any type of storage device configured to store data, programs, and other information and to make the data, programs, and other information accessible via the bus 348. In a preferred embodiment, the mass storage device 342 is configured to store the emulation program to be executed by the CPU 338. The mass storage device 342 may comprise, for example, one or more of a hard disk drive, a magnetic disk drive, an optical disk drive, or the like.

The video adapter 344 and the I/O interface 346 provide interfaces to couple external input and output devices to the processing unit 330. As illustrated in FIG. 3, examples of input and output devices include the display 334 coupled to the video adapter 344 and the mouse/keyboard 332 and the printer 336 coupled to the I/O interface 346. Other devices may be coupled to the processing unit 330.

The processing unit 330 may also include a network interface (not shown) and/or a wireless interface (not shown). The network interface allows the processing unit 330 to communicate with remote units via a network (not shown). In an embodiment, the processing unit 330 is coupled to a local-area network or a wide-area network to provide communications to remote devices, such as other processing units, the Internet, or the like. The network interface may provide an interface for a wired link, such as an Ethernet cable or the like, or a wireless link.

It should be noted that the emulation system 110 may include other components. For example, the emulation system 110 may include power supplies, cables, a motherboard, removable storage media, cases, and the like. These other components, although not shown, are considered part of the emulation system 110.

It should also be noted that the emulation system 110 may be coupled to the handheld computing device 210 via a wireless or wired connection. In this manner, the handheld computing device 210 may be used as an input device, thereby allowing the user to move around the classroom. Communicatively coupling the handheld computing device 210 to the emulation system 110 is discussed further in co-pending U.S. patent application Ser. No. ______ (Attorney Docket No. TI-37613), which is incorporated herein by reference.

The functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise. In other embodiments, however, a hardware system may be specifically designed to perform one or more of the functions described herein.

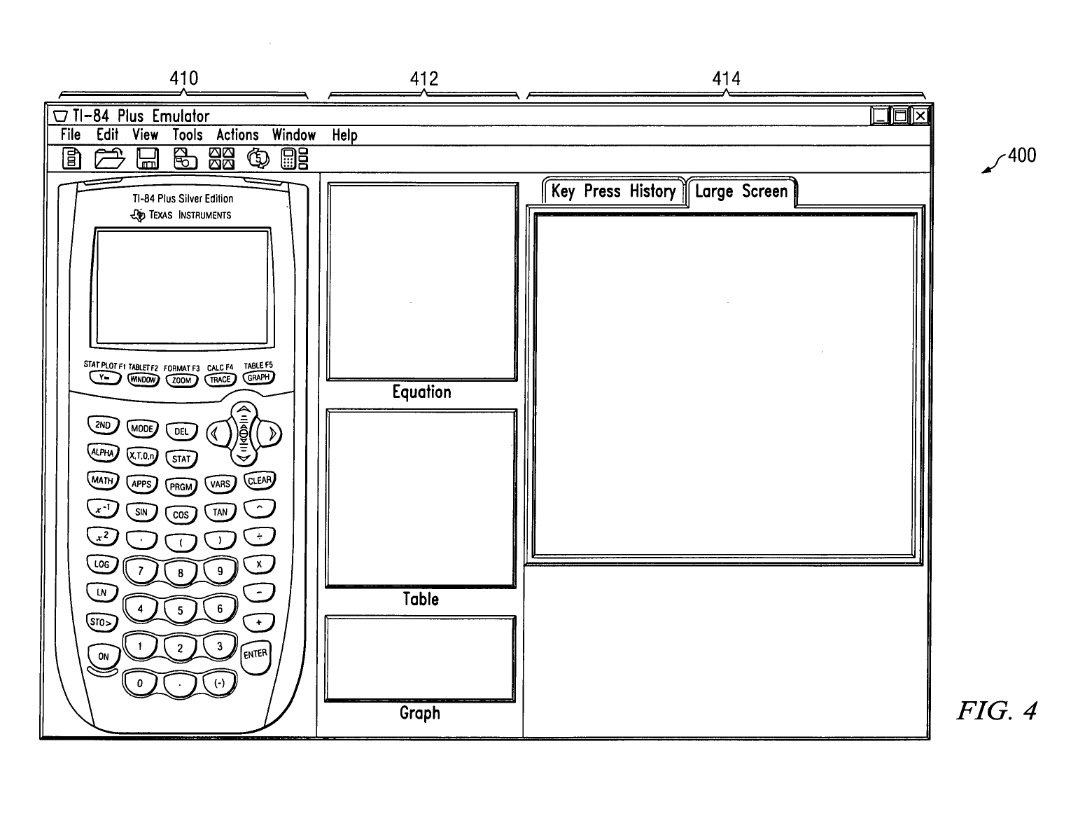

FIG. 4 is a display 400 generated by the emulation system 110 in accordance with an embodiment of the present invention. Generally, the display 400 includes a calculator-representation section 410, a calculator-display section 412, and a key press history section 414. The calculator-representation section 410 comprises a graphical representation of the handheld computing device 210 that the emulation system 110 emulates. For example, if the handheld computing device 210 is the TI-84 Plus calculator illustrated in FIG. 2, then the calculator-representation section 410 displays a graphical representation of the TI-84 Plus calculator. By displaying a graphical representation of the actual physical device, the students are able to easily relate the use of the emulator to the actual device.

The calculator-display section 412 illustrates the display that would be presented on the handheld computing device 210 if the data/functions entered on the emulation system 110 were entered on the handheld computing device. The display may include text, graphs, prompts, charts, plots, or the like.

The key press history section 414 provides a section in which the keystrokes that have been entered by the user are displayed. The information may represent, for example, a series of digits, commands (e.g., store, recall, graph, list, print, etc.), or functions (e.g., x², x³, compute, tan, sin, cos, etc.). In this manner, if a student misses a keystroke when trying to follow along with the teacher, the student is able to see the keystrokes entered by the teacher on the display. This allows the student to learn the key presses quicker and easier, and saves valuable classroom time by not requiring the teacher to repeat the key strokes missed by some of the students.

In a preferred embodiment, the keystrokes are represented by key-shaped symbols, such as a rectangle with rounded corners and are placed in sequence order from left to right and from top to bottom. It should be noted that some keys have multiple functions that are enabled by, for example, a “2ND” key. In these situations, it is preferred that the second key be indicated by either the primary function of the key, typically marked on the key itself. In alternative embodiments, the second key may be indicated by the secondary function (the function being invoked), typically marked above the key, or the combination of the keys depressed may be shown as a single key representing the function invoked. For example, as illustrated in FIG. 2, the “LOG” key has a secondary function of “10^{x}”, whereby the secondary function is invoked by depressing the “2ND” key followed by the “LOG” key. In the preferred embodiment, the key press history illustrates the “2ND” key followed by the “LOG” (the key depressed). In alternative embodiments, the key press history may illustrate the “2ND” key followed by the “10^{x}” key (the function invoked) or simply illustrate the “10^{x}” key (the combination of keys).

The key press history section 414 may be cleared by any method desirable. In an embodiment, the key press history section 414 is cleared when the clear (“C”) key is depressed. In other embodiments, however, the key press history section 414 is cleared by a command specific to the emulation system 110 to clear the key press history section 414. The command may comprise a button displayed on the GUI display of the emulation system 110, wherein the button may be clicked on by the user.

In yet another embodiment, the key press history section 414 may include a scrolling feature wherein the older key presses are scrolled off to make room for the new key presses. In this embodiment, it may be desirable to include scroll bars in the key press history section 414 such that a user may scroll back to see previous keystrokes that have scrolled off the display. This may be particularly useful if an exercise involved a long series of key presses have been entered and it is desirable to retain the complete key press history of the exercise.

It should also be noted that the key press history preferably indicates all input made to the emulation system 110, regardless of how the input is entered. For example, as discussed above, the emulation system 110 may be communicatively coupled to a handheld computing device, upon which information may be entered to the emulation system 110. In this embodiment, it is preferred that the keystrokes entered on the handheld computing device 210 be displayed in the key press history section 414. In this manner, students are able to visualize the keystrokes entered by the teacher regardless of the input device actually being used.

It should be noted that functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise. In other embodiments, a hardware system may be specifically designed to perform one or more of the functions described herein.

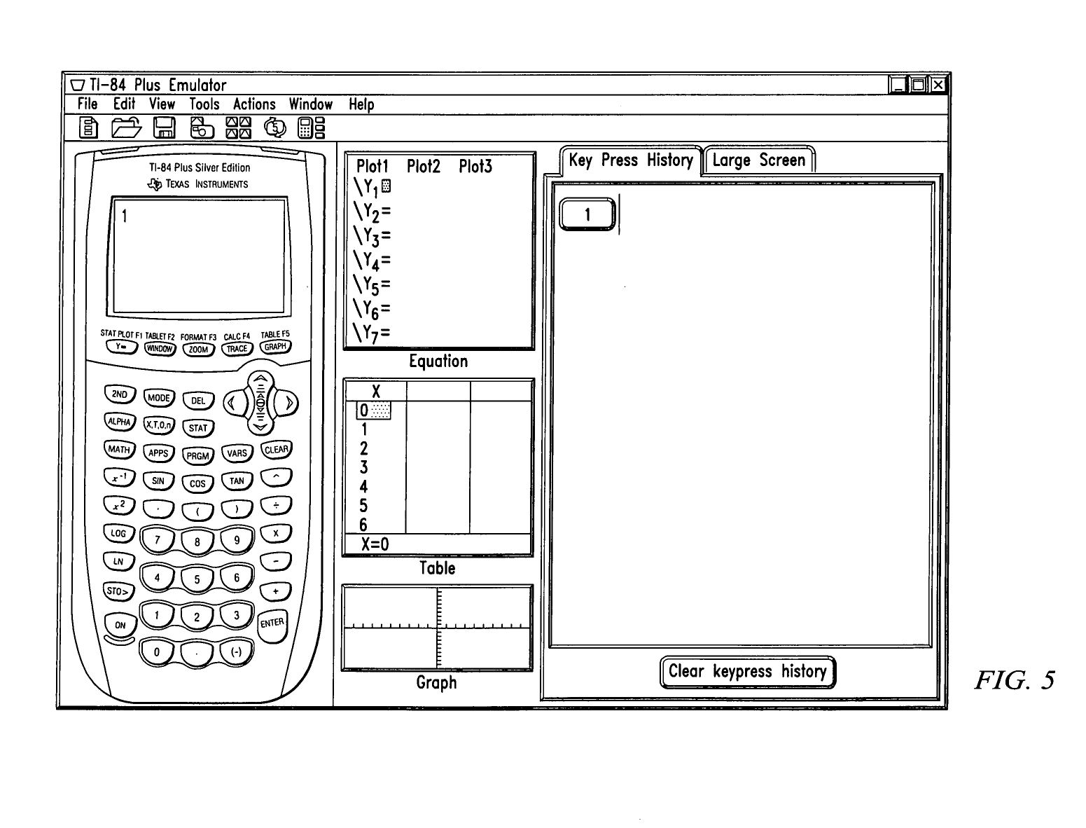

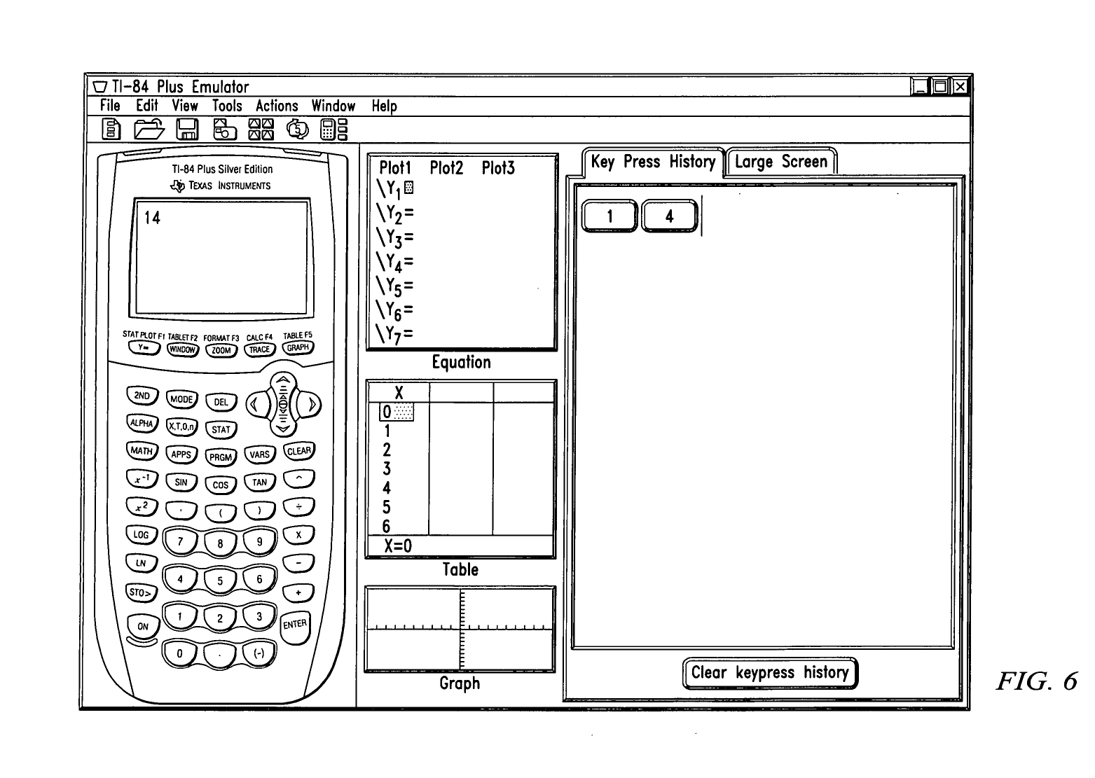

FIGS. 5-10 are a series of screen shots that illustrate an example of an emulation system in accordance with an embodiment of the present invention. Referring first to FIG. 5, an initial display is shown wherein a user of the emulation system initially depresses the “1” key. The key press history section provides a graphical representation of the “1” key, which may be projected as discussed above for viewing by a group of students. Next, in FIG. 6, a user depresses the “4” key. A graphical representation of the “4” key is added after the graphical representation of the “1” key in the key press history.

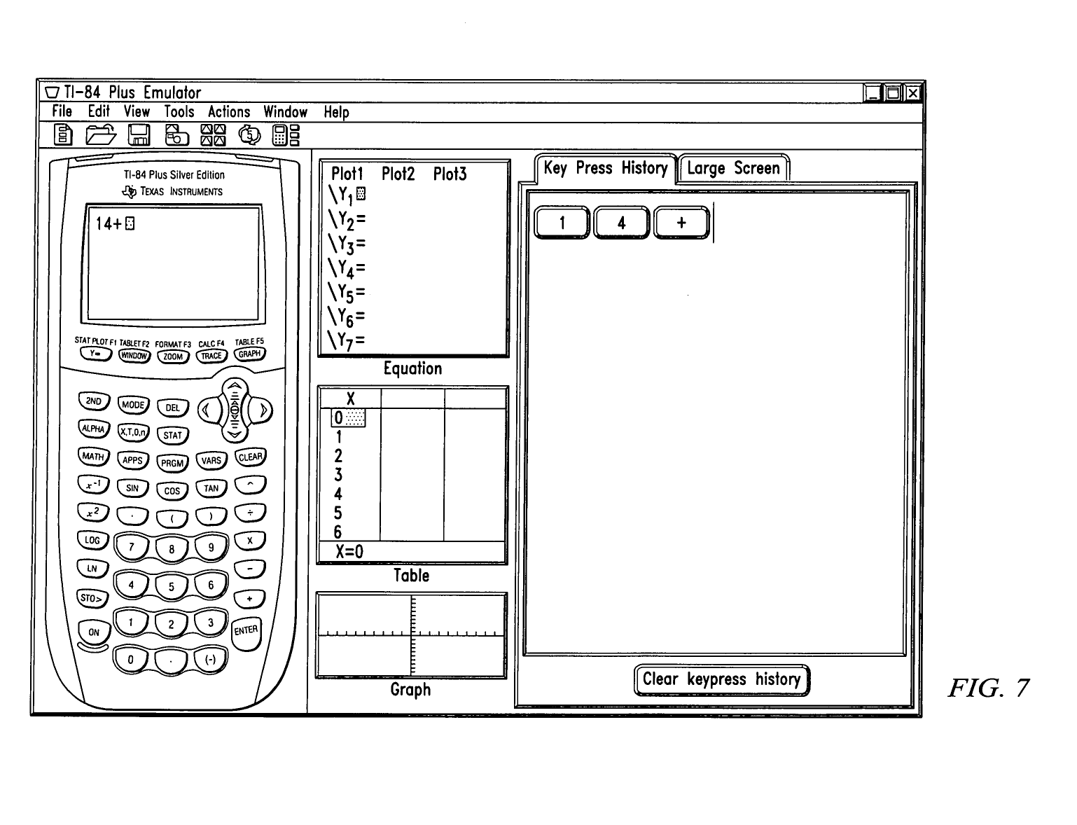

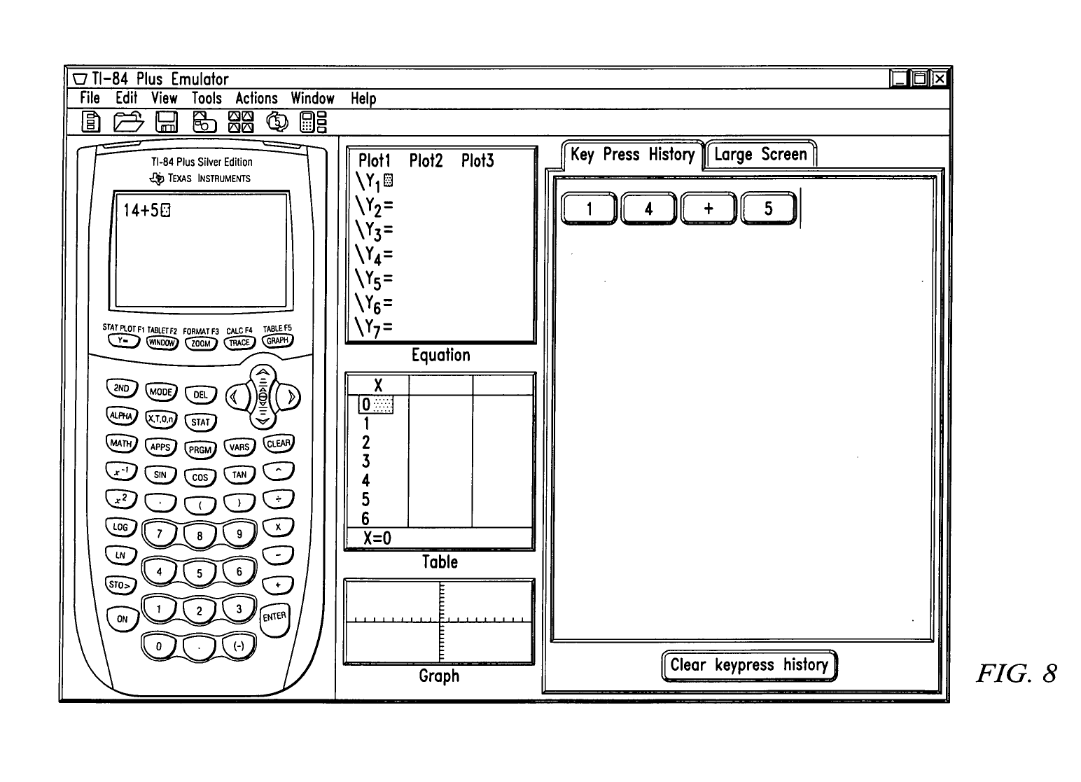

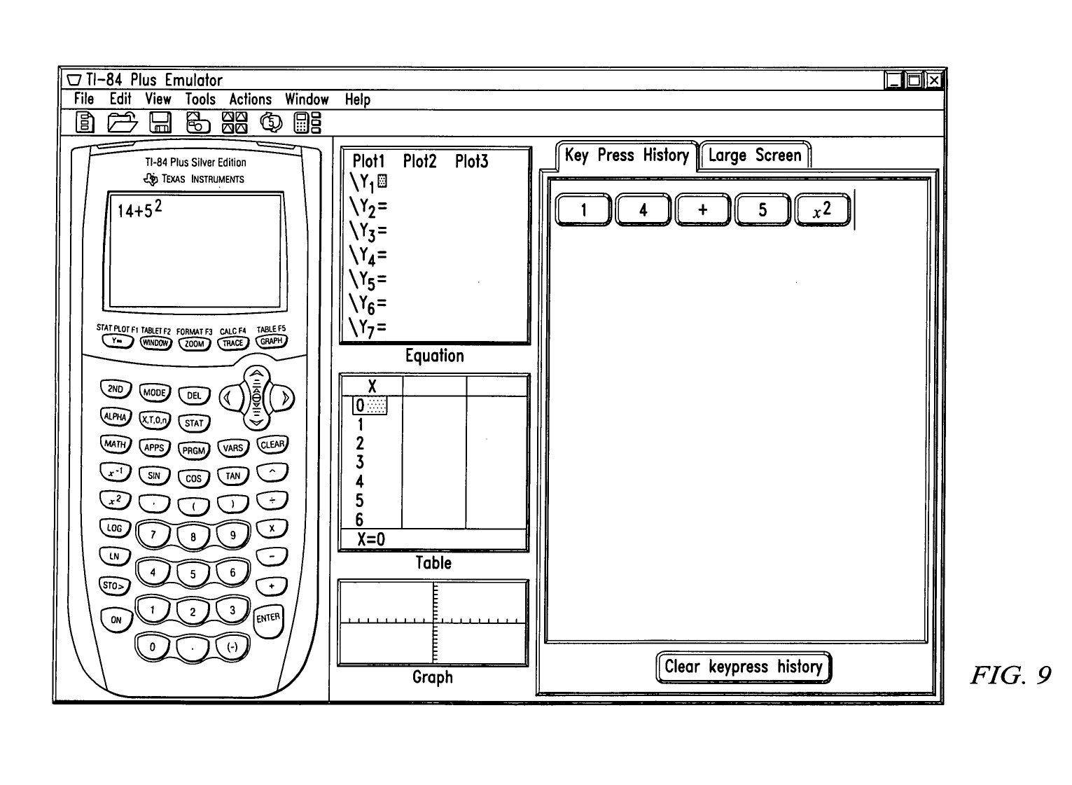

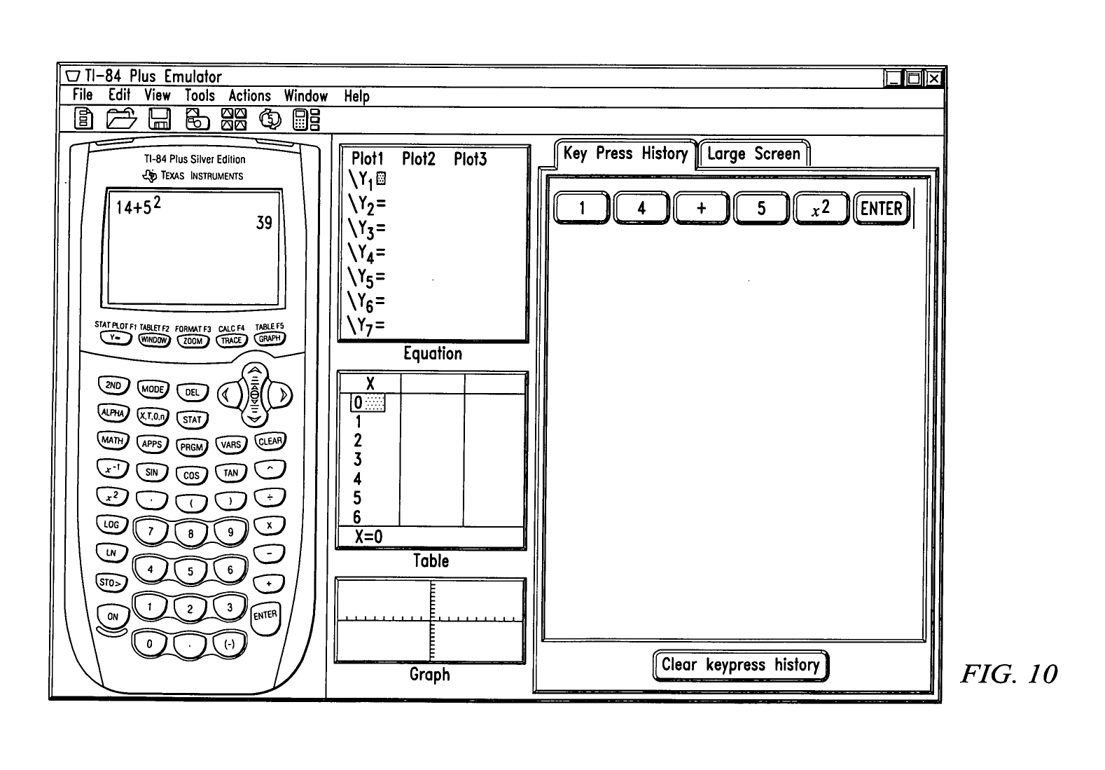

FIG. 7 illustrates the display of the emulation system after the “+” key is depressed, and FIG. 8 illustrates the display after the “5” key has been depressed. Next, FIG. 9 illustrates the display of the emulation system after the function key “x²” is depressed. Finally, FIG. 10 illustrates the display after the “Enter” key is depressed. A user may clear the screen by depressing the button labeled “Clear keypress history” on the bottom right of the FIG. 10.

As one of ordinary skill in the art will appreciate, the above example illustrates how the key press history may provide a graphical representation of the keys depressed. While the example illustrated above is a relatively simple example, the present invention is particularly useful when a user is attempting to illustrate a complicated concept using the emulation system.

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An emulation system comprising:
a processor configured to perform mathematical operations, the mathematical operations corresponding to mathematical operations available on a handheld computing device;
a display communicatively coupled to the processor; and
memory communicatively coupled to the processor, the memory being configured to store computer program code to cause the processor to receive a sequence of keystrokes, emulate the handheld computing device in accordance with the sequence of keystrokes, and display a key press history.

2. The emulation system of claim 1, wherein the handheld computing device comprises a calculator.

3. The emulation system of claim 1, wherein the key press history comprises a visual representation of the sequence of keystrokes.

4. The emulation system of claim 1, wherein the sequence of keystrokes is received from the handheld computing device.

5. The emulation system of claim 1, wherein the sequence of keystrokes is received from an electronic device configured to emulate the handheld computing device.

6. The emulation system of claim 1, wherein the key press history is displayed using a graphical representation of keys indicated by the sequence of keystrokes.

7. The emulation system of claim 1, further comprising an input port communicatively coupled to the processor and the handheld computing device and wherein the memory is further configured to store computer program code to receive the sequence of keystrokes from the handheld computing device.

8. A computer program product for providing input to an emulator, the computer program product having a medium with a computer program embodied thereon, the computer program comprising:
computer program code for emulating a handheld device;
computer program code for receiving input indicating a plurality of keys that have been depressed, the keys corresponding to keys of the handheld device; and
computer program code for displaying a key press history, the key press history indicating the plurality of keys that have been previously depressed.

9. The computer program product of claim 8, wherein the handheld device is a calculator.

10. The computer program product of claim 8, wherein the computer program code for receiving input includes computer program code for receiving input from the handheld device.

11. The computer program product of claim 8, wherein the computer program code for receiving input includes computer program code for receiving input from an electronic device configured to emulate the handheld device.

12. The computer program product of claim 8, wherein the computer program code for displaying includes computer program code for providing a graphical representation of a depressed key.

13. A method of instruction of students in a classroom, the method comprising:
displaying an output of an emulation device to a plurality of students, the emulation device emulating a calculator;
receiving a sequence of keystrokes, the sequence corresponding to a plurality of keys located on the calculator;
emulating behavior of the calculator in accordance with the sequence of keystrokes; and
displaying a key press history, the key press history including an indication of the sequence of keystrokes in order in which the sequence of keystrokes were received.

14. The method of claim 13, wherein the sequence of keystrokes is received from the calculator.

15. The method of claim 13, wherein the sequence of keystrokes is received from an electronic device configured to emulate the calculator.

16. The method of claim 13, further comprising clearing the key press history.

17. The method of claim 13, wherein the displaying includes displaying a graphical representation of a depressed key.

18. The method of claim 13, wherein the calculator is a graphing calculator.

19. The method of claim 13, wherein the students are in grade level from sixth grade to twelfth grade.
